(19) United States
(12) Patent Application Publication
(10) Pub. No.: US 2012/0081048 A1
(43) Pub. Date: Apr. 5, 2012

(54) MOTOR ABLE TO WORK SYNCHRONOUSLY AND AS INDUCTION MOTOR

(76) Inventors: Flavio J.H. Kalluf, Joinville (BR); Cristofaro Pompermaier, Joinville (BR)

(21) Appl. No.: 13/262,534

(22) PCT Filed: Mar. 25, 2010
(86) PCT No.: PCT/BR2010/000103

§ 371 Date: Dec. 14, 2011

(30) Foreign Application Priority Data
Mar. 31, 2009 (BR) PI0900907-8

(51) Int. Cl. H02K 21/12; H02P 6/08

(52) U.S. Cl. 318/400.09; 310/156.01

(57) ABSTRACT

The present invention relates to a motor that acts both as a synchronous motor and as an induction motor, and that comprises a stator (100) having coil windings, a rotor (200), where said rotor is a rotor with magnets (300, 310, 320, 330) generating 4 poles, and the windings of the stator (100) can be switched so as to change the number of poles. The subject motor acts as a synchronous motor when in low rotation and as an induction motor when in high rotation. During its operation as an induction motor, rotors (200) are utilized having a protuberance ratio near 1, generating a sufficient flux to reach good efficiency levels with 2 poles, which prevents the motor from having torque oscillations during its operation, providing a motor with a lighter operation and a better performance and less noise.

### FIELD OF THE INVENTION

The present invention relates to a synchronous and induction motor and, more particularly, to a motor, which works both as a synchronous motor and as an induction motor, showing a configuration that, allows a good performance of the same in both situations.

### BACKGROUND OF THE INVENTION

Nowadays, the compressor motors for refrigeration have an important function in the consumption of energy in these compressors. Among the important features of these motors, one may point out as the main ones: the electric output, the robustness during the startup (or overloads) and the possibility of varying the speed of the same.

There are three types of motor utilized in compressors for refrigeration that equip more than 90% of the total found in the field, either in household applications or in commercial applications: the mono-phase induction motor, the synchronous motor with permanent magnets and the brushless DC motor with permanent magnets.

In the mono-phase induction motor, the torque is high, generated through the interaction between the stator field and the field induced in the rotor. The electric efficiency of this type of motor is reasonable (average), the use of an electronic control is not necessary and its speed is constant. This makes this type of motor a low cost motor.

In the synchronous motor with permanent magnets with direct startup (LSPM) in turn, the torque is low, generated by the interaction between the magnet field ant the stator currents. In this type of motor, it is not necessary any type of electronic control either, and its speed is also constant. However, its efficiency is high when compared with that of the induction motor. This type of motor is a medium cost motor.

Finally, the brushless DC motor with permanent magnets, different from the others, makes use of an electronic control, an inverter, to control the efficient current magnitude in the stator, which, together with the field generated by the rotor, produces torque. For having the electronic control, its speed is controllable since the conduction time of the transistors can be adjusted. However, this kind of solution has a high cost, due to the need for using a fairly complex electronic device.

Such types of motor can be observed, as examples, in documents U.S. Pat. No. 3,978,356, U.S. Pat. No. 4,139,790, U.S. Pat. No. 5,631,512, U.S. Pat. No. 5,825,112, U.S. Pat. No. 6,917,133, U.S. Pat. No. 7,116,030, U.S. Pat. No. 7,183,686 and U.S. Pat. No. 7,372,183.

### SUMMARY OF THE INVENTION

The present invention consists of a motor with a mixed configuration of a synchronous motor and an induction motor allowing the operation at two speeds without the use of electronic devices inherent to brushless DC motors, resulting in a motor with high levels of efficiency and variable speed, and yet at a competitive cost.

Therefore, it is an object of the present invention to provide a motor which allows the variation of the speed without the use of electronic devices.

It is another object of the present invention to provide a motor which has a better performance/cost relation than the current motors, or, in other words, to allow a better performance of the motor at a low cost.

It is still another object of the invention to provide a motor having the features of a synchronous motor and an induction motor, under certain conditions.

It is a further object of the present invention to provide a motor with a lower noise level for working synchronized and at speeds lower than the usual ones.

The objects of the present invention are achieved by the provision of a synchronous and induction motor, comprising a stator having coil windings, a rotor having magnets that generate n poles and additionally comprising a stator with coil windings arranged so that they allow the change of the n poles of said stator through a switch, so as to operate at a low rotation as a synchronous motor and at a high rotation as an induction motor, wherein, during the operation as an induction motor, a rotor is used with a protuberance ratio Xd/Xq (ratio between the direct shaft and the quadrature shaft reactances) near 1.

### BRIEF DESCRIPTION OF THE DRAWINGS

The invention will be now described in further detail, in conjunction with the drawing listed below illustrative of the invention. Note that, though the examples below use the 2 to 4 pole configuration for a better understanding, the solution is not restricted to this combination, and any other combinations of numbers of poles may be used according to the application needs.

FIG. 1A illustrates a 2 pole configuration of the motor stator of the present invention, showing the current direction.

FIG. 1B illustrates the 2 pole configuration of the motor stator of FIG. 1A, showing the magnetic flux direction;

FIG. 1C illustrates the 4 pole configuration of the motor stator of the present invention, showing the current direction;

FIG. 1D illustrates a 4 pole configuration of the motor stator of FIG. 1C, showing the magnetic flux direction;

FIG. 1E illustrates an alternative 2 pole configuration of the motor stator of the present invention, showing the current direction;

FIG. 1F illustrates an alternative 4 pole configuration of the motor stator of the present invention, showing the current direction;

FIG. 2 illustrates a 4 pole configuration of a rotor with magnets according to the present invention, showing the magnet field direction;

FIG. 3A represents the field chart of an exemplary motor with the rotor direct shaft aligned with the shaft of the stator main coil;

FIG. 3B represents the field chart of said motor of FIG. 3A, with the rotor direct shaft at 90° from the shaft of the stator main coil;

FIG. 4A is an alternative exemplary topology of a rotor configuration according to the present invention; and

FIG. 4B is an alternative exemplary topology of a rotor configuration according to the present invention.

### DETAILED DESCRIPTION OF THE PREFERRED EMBODIMENT

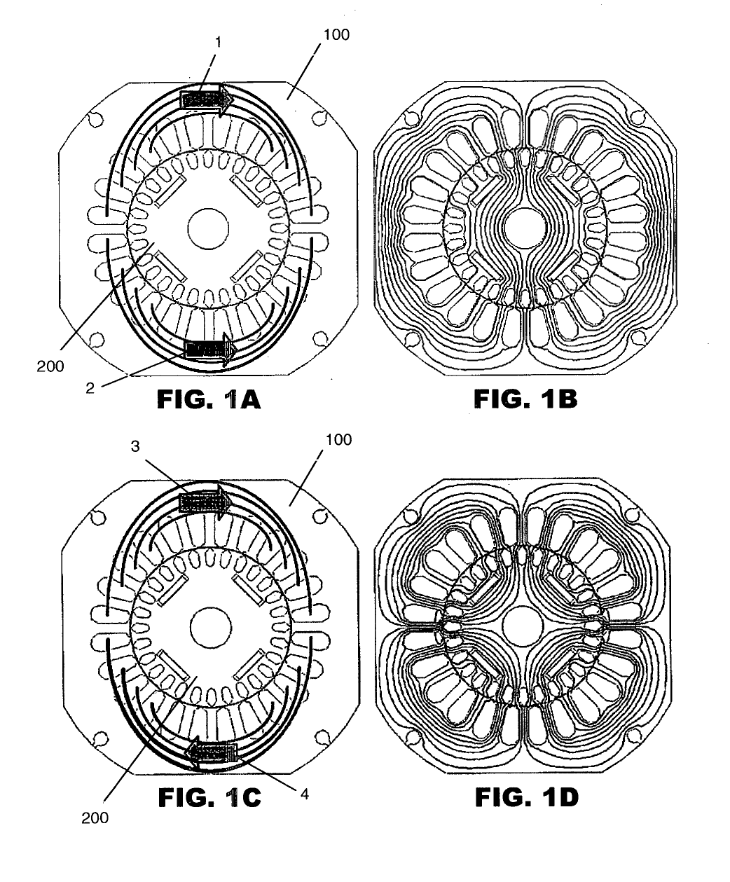

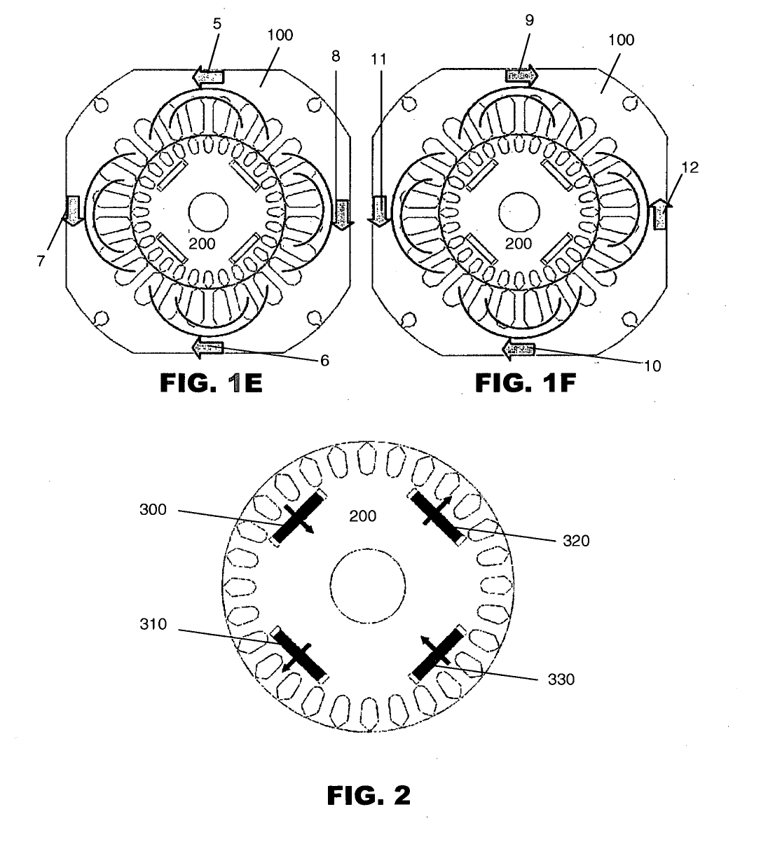

FIGS. 1A and 1B illustrates a stator 100 with windings in a configuration that generates 2 poles.

As can be seen from FIG. 1A, the current both in the upper portion and the lower portion has the same direction in this configuration (from the left to the right), these currents being represented by arrows 1 and 2.

FIG. 1B in turn illustrates the magnetic flux direction of the configuration illustrated in FIG. 1A.

FIGS. 1C and 1D illustrate, differently from FIGS. 1A and 1B, a stator 100 with windings in a configuration that generates 4 poles.

FIG. 1C illustrates the 4 pole configuration of the winding of stator 100, where arrows 3 and 4 show the current in the upper and lower portions with opposite directions (upper—from the left to the right and lower—from the right to the left).

FIG. 1D illustrates the magnetic flux of the configuration illustrated in FIG. 1C, forming 4 poles.

The configurations illustrated in FIGS. 1A to 1D are merely examples of the plurality of configurations that may exist to transform stator 100 with a 2 pole winding into a stator 100 with a 4 pole winding.

These winding configurations of the stator 100 with 2 or 4 poles may alternate through the driving of electronic and/or electro-mechanical switches.

Additional configurations are illustrated in FIGS. 1E and 1F. FIG. 1E illustrates an alternative 2 pole configuration of the winding of stator, where arrows 5 to 8 show the direction of the currents in said winding configuration, the current in the upper and lower portions having the same direction (from the right to the left) and having the same direction in the right and left portions (from the top to the bottom).

In the example of stator 100 with a 4 pole winding configuration, illustrated in FIG. 1F, the current in the upper and lower portions has an opposite direction (upper portion—from the left to the right, and lower portion—from the right to the left), and the current in the right and left portions also has an opposite direction (right portion—from the bottom to the top, and left portion—from the top to the bottom), as can be noted from arrows 9 to 12.

Apart from the configurations illustrated in the appended figures, countless other winding configurations may be utilized, such as 2 and 4 pole independent windings that have differential features, such as an additional efficiency gain, though the cost for using such a configuration is higher.

As mentioned above, the winding configurations of stator 100 with 2 or 4 poles may alternate through the driving of electronic switches, for example, transistors, and/or electro-mechanical switches, for example, relays, being controlled by an outer control system which is responsible for evaluating the need for using the motor at low or high rotation, thus causing the switching between the winding configurations, by way of voltage and/or current signals.

With reference to FIG. 2, a rotor 200 is illustrated with magnets 300, 310, 320, 330 forming, for example, 4 poles, where magnets 300, 310, 320, 330 will allow the synchronization of the motor in a low speed condition. The operation of the motor as a motor with permanent magnets with direct startup in the network (LSPM) allows this motor to operate with high efficiency in the low speed condition. In FIG. 2, the arrows indicate the magnetic field direction of magnets 300, 310, 320, 330 and, as can be noted, magnets in opposite positions have field opposite directions. As an example, from said figure, the magnets of the upper left and lower right quadrants 300, 330 have the reverse field direction (a 180° difference) in relation to one another, and the same occurs for the upper right and lower left magnets 310, 320. This configuration results in the generation of 4 poles in the rotor, however a higher number of poles may be used depending upon the desired rotation for the low speed configuration. As an example, 2 pole (high rotation) and 4 pole (low rotation), or even 4 pole (high rotation) and 6 pole (low rotation) configurations, or yet any other combination that brings specific advantages to the application the motor is intended for.

As in rotor 200, there is no switching and, it being a 4 pole rotor, it will always have 4 poles, a configuration is desired that allows a satisfactory operation both for 2 poles (induction motor) and for 4 poles (synchronous motor), In order to provide this special configuration, it is necessary that some constructive requirements be met. These are: a) the flux generated by magnets 300, 310, 320, 330 must be high enough to generate a reasonable torque and efficiency level during the operation as a 4 pole (synchronous) motor; and b) the reluctance ratio (Xd/Xq) between the direct (Xd) and the quadrature shafts (Xq) as seen by the 2 pole winding must be near 1, so as to generate a reluctance torque near zero during the 2 pole operation of rotor 200, allowing reasonable efficiency levels to be reached and avoiding torque oscillations at nominal speed. It should be noted here the reluctance ratio or the protuberance ratio is the relation between the reluctance of the electric direct and quadrature shafts of a rotor. Thus, the larger the relation, the larger the reluctance torque will be near the synchronous rotation.

The protuberance ratio Xd/Xq being near 1, high rotation torque oscillations are avoided (2 poles in the example mentioned).

Another important requirement is that the magnets be symmetrically arranged and have exactly the same format and magnetic features. This fact will assure that the average torque generated by the magnet flux in 2 poles is null.

On meeting these requirements specified above, the motor is prevented from having torque oscillations during its 2 pole operation. The torque oscillation, a harmonic variation in the motor output torque, contributes to vibration, noise and the variation of rotation in the machines. Thus, the configuration described by the present invention generates a motor with a lighter operation, less noise and better performance.

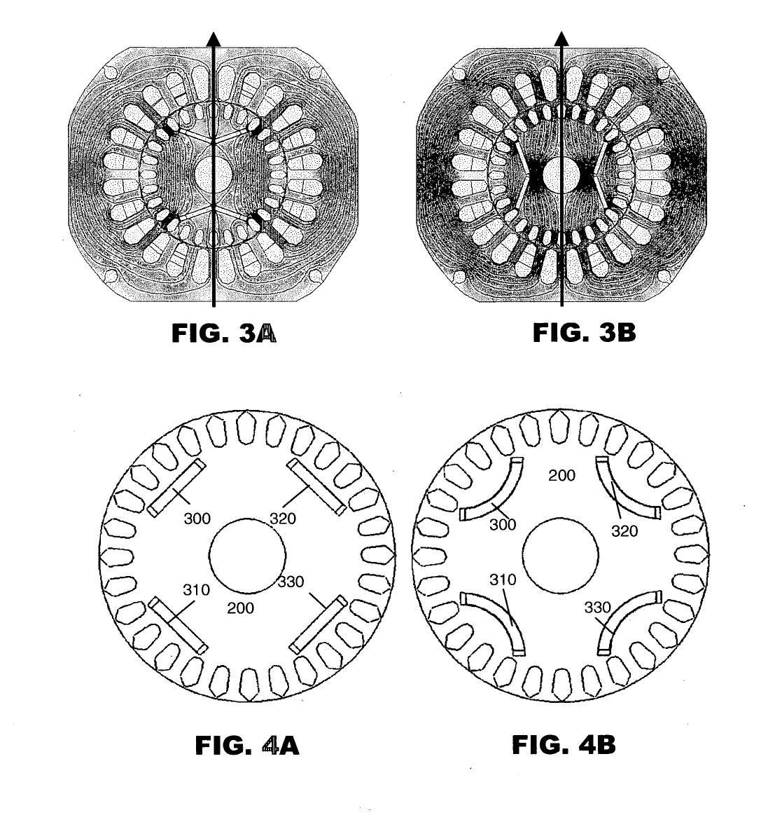

FIGS. 3A and 3B illustrate an exemplary reluctance ratio, where FIG. 3A represents the direct electric shaft with a higher reluctance and less flux, while FIG. 3B represents the quadrature electric shaft with less reluctance and a higher flux. The arrow in FIG. 3A indicates the shaft with the highest reluctance, while the arrow in FIG. 3B indicates the shaft with the lowest reluctance.

Based on the need for having the reluctance ratio next to 1, a plurality of configurations of rotor 200 may be utilized, still generating a flux high enough for the proper operation of rotor 200. In this manner, the illustrative configurations in FIGS. 4A and 4B meet both of the requirements needed for the operation of rotor 200 both with 2 poles and with 4 poles.

FIG. 4A depicts flat magnets, while FIG. 4B depicts curved magnets (concave shape). It is apparent that the two configurations depicted in FIGS. 4A and 4B are merely examples and that other configurations of rotor magnets 300, 310, 320, 330 may be provided where the requirements for an optimum operation will be met.

Although the above description refers to a preferred embodiment, it should be appreciated by those skilled in the art that the present invention is not limited to the details of the above teachings.

It should be noted that variations, modifications and changes to the invention herein described are possible to those skilled in the art, without departing from the spirit and scope of the present invention or equivalents of the same, as embraced by the appended claims and their equivalents.

1-7. (canceled)

8. A synchronous and induction motor, comprising:
a stator having coil windings;
a rotor having magnets;
the motor being additionally CHARACTERIZED in that the rotor with magnets generates n poles, and in that it additionally comprises a stator with coil windings arranged so as to allow the number of poles in said stator to alternate through a switch, in order to operate in low rotation as a synchronous motor and in high rotation as an induction motor;
wherein the number of poles in the stator winding for the operation in low rotation as a synchronous motor is equal to the number of poles n in the rotor;
wherein the number of poles in the stator winding for the operation in high rotation as an induction motor is an even number and an integer between 2 and n−2;
wherein, during the operation as an induction motor, a rotor is utilized having a protuberance ratio (Xd/Xq) near 1.

9. A synchronous and induction motor, according to claim 8, CHARACTERIZED in that said switch is an electronic switch.

10. A synchronous and induction motor, according to claim 8, CHARACTERIZED in that said switch is an electro-mechanical switch.

11. A synchronous and induction motor, according to claim 8 CHARACTERIZED in that an outer control system evaluates the need for operation either in high or low rotation.

12. A synchronous and induction motor, according to claim 9 CHARACTERIZED in that an outer control system evaluates the need for operation either in high or low rotation.

13. A synchronous and induction motor, according to claim 10 CHARACTERIZED in that an outer control system evaluates the need for operation either in high or low rotation.

14. A synchronous and induction motor, according to claim 8, CHARACTERIZED in that the magnets of rotor are flat magnets.

15. A synchronous and induction motor, according to claim 8, CHARACTERIZED in that the magnets of rotor are concave magnets.

16. A synchronous and induction motor, according to claim 8, CHARACTERIZED in that the stator windings for low and high rotation are independent.
